(19) United States
(12) Patent Application Publication
(10) Pub. No.: US 2026/0093615 A1
(43) Pub. Date: Apr. 2, 2026

(54) CONTROL INFORMATION STORAGE

(71) Applicant: Arm Limited, Cambridge (GB)

(72) Inventors: David Michael BULL, Cambridge (GB); Stefano GHIGGINI, Antibes (FR)

(21) Appl. No.: 18/806,907

(22) Filed: Aug. 16, 2024

(51) Int. Cl. G06F 12/02

(52) U.S. Cl. CPC G06F 12/0215; G06F 12/0848; G06F 12/0862; G06F 12/0891; G06F 12/1027; G06F 12/0864; G06F 2212/654

(57) ABSTRACT

An apparatus comprises first control information storage and second control information storage, to store control information entries corresponding to a given address and providing control information for controlling processing operations relating to the given address. Lookup circuitry is configured to perform a precise lookup operation in the first control information storage to identify a target control information entry corresponding to a target address determined based on a plurality of target address calculation operands, and perform an imprecise lookup operation in the second control information storage to identify the target control information entry based on an imprecise lookup value. Checking circuitry is configured to cause a miss to be detected in the second control information storage in response to determining that the imprecise lookup value does not correspond to the target address.

### BACKGROUND

### Technical Field

The present technique relates to the field of data processing.

### Technical Background

Data processing devices may provide storage structures for storing control information for controlling processing operations. Increasing a number of entries which may be supported by control information storage may provide improved performance, as it may increase the likelihood that control information for a particular processing operation is stored in the control information storage and can hence be accessed more quickly. However, time required to access control information storage may scale poorly with increased numbers of entries.

### SUMMARY

At least some examples of the present technique provide an apparatus, comprising: first control information storage and second control information storage, wherein the first control information storage and the second control information storage are configured to store a plurality of control information entries, each control information entry corresponding to a given address and providing control information for controlling processing operations relating to the given address;
lookup circuitry configured to:
   perform a precise lookup operation in the first control information storage to identify a target control information entry corresponding to a target address determined based on a plurality of target address calculation operands, and
   perform an imprecise lookup operation in the second control information storage to identify the target control information entry based on an imprecise lookup value determined based on at least one of the target address calculation operands; and checking circuitry configured to cause a miss to be detected in the second control information storage in response to determining that the imprecise lookup value does not correspond to the target address determined based on the plurality of target address calculation operands.

At least some examples provide a method, comprising:
storing a plurality of control information entries in first control information storage and second control information storage, each control information entry corresponding to a given address and providing control information for controlling processing operations relating to the given address;
performing a precise lookup operation in the first control information storage to identify a target control information entry corresponding to a target address determined based on a plurality of target address calculation operands;
performing an imprecise lookup operation in the second control information storage to identify the target control information entry based on an imprecise lookup value determined based on at least one of the target address calculation operands; and
causing a miss to be detected in the second control information storage in response to determining that the imprecise lookup value does not correspond to the target address determined based on the plurality of target address calculation operands.

At least some examples provide computer-readable code for fabrication of an apparatus, comprising:
first control information storage and second control information storage,
wherein the first control information storage and the second control information storage are configured to store a plurality of control information entries, each control information entry corresponding to a given address and providing control information for controlling processing operations relating to the given address;
lookup circuitry configured to:
   perform a precise lookup operation in the first control information storage to identify a target control information entry corresponding to a target address determined based on a plurality of target address calculation operands, and
   perform an imprecise lookup operation in the second control information storage to identify the target control information entry based on an imprecise lookup value
determined based on at least one of the target address calculation operands; and checking circuitry configured to cause a miss to be detected in the second control information storage in response to determining that the imprecise lookup value does not correspond to the target address determined based on the plurality of target address calculation operands. The computer-readable code may be provided on a computer-readable storage medium. The storage medium may be non-transitory.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates an example of a data processing apparatus;

FIG. 2 schematically illustrates an apparatus comprising first control information storage and second control information storage;

FIG. 3 schematically illustrates an apparatus comprising a main TLB and an auxiliary TLB;

FIGS. 4 and 5 are flow diagrams illustrating methods of performing lookups for a target control information entry; and

FIG. 6 illustrates a system and a chip-containing product.

### DESCRIPTION OF EXAMPLES

An apparatus according to the present techniques comprises first control information storage. Control information entries in the first control information storage are configured to store control information for controlling processing operations relating to a given address. For example, the control information storage may comprise a translation lookaside buffer (TLB) and the control information entries may provide address translation information for translating the given address into a physical address identifying a physical location in memory. However, the present techniques are not so limited, and in other examples the control information storage may comprise a value prediction cache configured to store values predicted to be results of instructions identified by the given addresses, or a branch prediction cache configured to store prediction information associated with branch instructions identified by the given addresses, for example. The control information storage may in some examples comprise a control information cache to cache control information derived from a table structure stored in memory.

The apparatus comprises lookup circuitry configured to perform a precise lookup operation in the first control information storage to identify a target control information entry corresponding to a target address determined based on a plurality of target address calculation operands. The target address calculation operands may include, for example, a base address and an offset to be added to the base address to provide the target address. For the set of control information entries each corresponding to given addresses, a matching entry may be one for which the given address corresponds to the target address. The addition of the target address calculation operands may be performed in advance by a dedicated address generation unit (AGU) with the target address then being passed to the first control information storage, or the calculation may be integrated into the first control information storage and performed as part of the precise lookup operation.

The precise lookup operation may require the target address to be determined before the results of the lookup can be known. However, this may mean that the time required to complete the precise lookup operation in the first control information storage does not scale well with the number of control information entries in the first control information storage. In particular, as the number of entries in the first control information storage increases then a larger number of bits of the target address may be required to identify the target entry (e.g., a larger index may be required) and therefore there may be a larger delay whilst waiting for a sufficient number of bits of the target address to be calculated as the number of entries increases. In addition, as the number of control information entries increases, the physical size of the control information storage increases, and hence due to propagation delays the lookup operation may also take longer after waiting for the target address to be calculated. The additional calculation and lookup delays are incurred additively as the control information storage gets larger, and therefore increasing the number of entries in the first control information storage looked up using the precise lookup operation can make it significantly more difficult to meet timing demands.

According to examples of the present technique, the apparatus also comprises second control information storage, and the lookup circuitry is configured to perform an imprecise lookup operation in the second control information storage to identify the target control information entry based on an imprecise lookup value determined based on at least one of the target address calculation operands. Examples of determining the imprecise lookup value will be discussed below, but in general the imprecise lookup value may be determined without performing a full calculation of the target address. The imprecise lookup value may act as an estimate of at least a portion of the target address, such that if the estimate is correct and the imprecise lookup value corresponds to the target address then the same target control information entry is identified using the imprecise lookup value as would be obtained using the target address. The second control information storage may be provided as a different storage structure from the first control information storage, or may be provided as a separate partition within a shared structure.

The imprecise lookup operation may accurately identify a target entry for a given lookup value, with the imprecision in the imprecise lookup operation originating from the use of the imprecise lookup value rather than any inherent imprecision in the way the lookup value is used to identify a target entry. The imprecise lookup operation may be considered to be a second lookup operation in the second control information storage that is less precise than a first (precise) lookup operation in the first control information storage.

Timing of the imprecise lookup operation to identify the target control information entry in the second control information storage may scale better than the precise lookup operation. In particular, the imprecise lookup operation may be started in advance of the target address being determined, and therefore the delay of waiting for calculation of the target address (which may be larger as the number of entries increases, as discussed above) may not need to be incurred for the imprecise lookup operation. Therefore, providing the second control information storage looked up using the imprecise lookup operation may enable a larger number of control information entries to be supported whilst enabling timing requirements to be met.

The apparatus also comprises checking circuitry configured to cause a miss to be detected in the second control information storage in response to determining that the imprecise lookup value does not correspond to the target address determined based on the plurality of target address calculation operands. As the imprecise lookup value acts as an approximation of the target address, there may be cases when the imprecise lookup value does not accurately correspond to the target address and hence an entry identified using the imprecise lookup value may not be the same as an entry identified using the target address. Therefore, to prevent an incorrect entry being returned in response to the imprecise lookup operation, the checking circuitry causes the imprecise lookup operation to detect a miss in the second control information storage in response to determining that the imprecise lookup value does not correspond to the target address.

One might think that, if timing of the imprecise lookup operation scales better than the precise lookup operation, then overall performance would be improved by providing a single instance of control information storage looked up using the imprecise lookup operation, as this would appear to enable a larger number of control information entries to be supported for a given timing requirement. However, the inventors have realised that, counter-intuitively, overall performance can be improved by providing both the first control information storage looked up using the precise lookup operation and the second control information storage looked up using the imprecise lookup operation. In particular, compared to providing just the first control information storage, providing both the first and second control information storage can enable to total number of entries to be increased due to the improved scaling of the imprecise lookup operation, as discussed above. In addition, compared to providing just the second control information storage, providing both the first and second control information storage can enable independent forward progress to be maintained in cases where the approximation is incorrect and the imprecise lookup value does not correspond to the target address. In general, providing at least some entries looked up using the precise lookup operation can enable worst-case performance to be limited and avoid a requirement for a dedicated recovery mechanism to identify the correct entry in lookups where the imprecise lookup value does not correspond to the target address, because the precisely looked up first control information storage can provide a fall-back mechanism to enable forward progress to be made independently of the accuracy of the imprecise lookup operation.

For example, in some examples the apparatus comprises allocation circuitry responsive to a determination that the precise lookup operation for a given target address missed in the first control information storage and the imprecise lookup value did not correspond to the given target address, to allocate a control information entry corresponding to the given target address in the first control information storage. The allocation circuitry may obtain the control information for allocation in the first control information storage from a memory system.

If the imprecise lookup value did not correspond to the given target address, then it may be unknown following the imprecise lookup operation whether or not the second control information storage contains the target control information entry. One approach to determine whether the second control information storage contains the target control information entry may be to support a recovery mechanism to replay lookups in the second control information storage with a corrected lookup value corresponding to the correct target address. Supporting such a mechanism may incur a large power and area overhead, and the recovery mechanism may delay further lookups in the second control information storage. However, the inventors have realised that forward progress can be maintained in the absence of such a recovery mechanism by providing both first control information storage and second control information storage.

In particular, if the imprecise lookup value does not correspond to the target address (and the precise lookup missed in the first control information storage), the target control information entry can be allocated into the first control information storage. Then, a future lookup can identify the target control information entry in a precise lookup operation even if the imprecise lookup value for that entry does not correspond to the target address. In other words, upon failure of the imprecise lookup operation to correctly estimate the target address, the target control information entry can be provided in a location where it can be accessed in a future lookup without relying on the imprecise lookup value corresponding to the target address.

In some examples, the lookup circuitry may be responsive to a determination that the imprecise lookup value used for a given imprecise lookup operation does not correspond to the target address, to allow forward progress based on the miss in the second control information storage without attempting to repeat the given imprecise lookup operation using a lookup value corresponding to the target address. Forward progress may take different forms depending on the type of control information stored in the control information storage, and in general may involve allowing subsequent operations to proceed. As discussed above, providing both the first control information storage and the second control information storage enables forward progress to be maintained without supporting a recovery mechanism to replay the imprecise lookup operation, because it can allow data to be retrieved from memory to be accessed without relying on the imprecise lookup operation (even if the data was previously available, but inaccessible, in the second control information storage). If the first control information storage were not supported, then a recovery mechanism may be required so that if the imprecise lookup value for a particular target address does not correspond to that target address, there is a mechanism to access the target control information entry corresponding to the target address. Without the first control information storage, when the imprecise lookup value does not correspond to the target address, the recovery mechanism may be required to lookup the second control information storage again using an accurate lookup value. If the second control information storage is provided to increase the number of control information storage entries supported by an apparatus compared to use of a precisely-accessed first control information storage, the second control information storage would be expected to be a large structure (for example, larger than the first control information storage), and hence this replayed lookup may be expected to be slow. However, providing the first control information storage enables the target control information entry to be accessed (directly via the target address in a precise lookup in the first control information storage) even if it is not possible to access that entry via the imprecise lookup operation, without having to support a recovery mechanism and without having to wait for the large second control information storage to be looked up using a corrected lookup value.

In some examples, the lookup circuitry may be configured to initiate the imprecise lookup operation for a given target control information entry based on at least one of the target address calculation operands before the target address is made available. Initiating the imprecise lookup operation may comprise using the imprecise lookup value to identify one or more candidate control information entries believed to correspond to the target address. The apparatus may comprise calculation circuitry to determine the target address based on the target address calculation operands, and the lookup circuitry may initiate the imprecise lookup operation before the calculation circuitry is able to provide enough bits of the target address to perform the lookup. Hence, the imprecise lookup operation may enable a determination of whether the second control information storage comprises the target control information entry quicker than a precise lookup operation relying on using the target address once it has been determined.

As mentioned above, the imprecise lookup value may be determined in different ways in different examples of the present techniques.

In some examples, the apparatus may comprise address calculation circuitry to determine the target address based on a combination of a base address and an offset, and the lookup circuitry may be configured to exclude the offset from determination of the imprecise lookup value. For example, the imprecise lookup value may be determined based entirely on the base address. In some examples, the imprecise lookup value may comprise a portion of the base address. The portion may comprise a lowest bit significance slice of a page address portion of the base address used to identify a memory page. Using the lowest bit significance slice may reduce the likelihood of control information entries accessed at similar times (which may for example be in similar areas of memory) having the same imprecise lookup value, and may therefore reduce the likelihood of temporally close lookups hitting against the same set within the second control information storage.

The inventors have realised that when a target address is determined by adding an offset to a base address, the base address may often belong to the same memory page as the target address. The offset may for example commonly be a relatively small offset which does not cross a page boundary. In some cases, the same control information entry may be identified in at least an initial portion of the lookup for all addresses within the same memory page (e.g., where the control information provides the same information for all addresses within a memory page, such as when the control information is translation information in a TLB), meaning that if the lookup is performed on the basis of the base address then the lookup may identify the same entry as if it were performed on the basis of the target address when the target address is in the same memory page. Hence, using the base address to form the imprecise lookup value without the offset value may provide an imprecise lookup value which is often correct (and hence the checking circuitry will infrequently force a miss) and which may require significantly less calculation than calculating the target address, because it does not require the offset to be added to the base address prior to performing the lookup.

In some examples, however, the lookup circuitry may determine the imprecise lookup value based on a combination of the base address and the offset. In such cases, the lookup circuitry may be configured to determine the imprecise lookup value based on an imprecise combination of the base address and offset. For example, whilst the target address may be based on a full addition of the base address and offset, the imprecise lookup value may be based on a partial addition or approximation of an addition of the base address and the offset. Using the offset to determine the imprecise lookup value, even in an imprecise combination, may improve accuracy of identifying entries compared to use of the base address alone. By performing an imprecise combination of the base address and offset, the imprecise lookup value may be determined more quickly than calculating the target address, hence enabling the imprecise lookup operation to be performed more quickly than the precise lookup operation.

For example, the imprecise lookup value may be based on a combination of at least a portion of the base address with a select number of bits of the offset, excluding at least some of the offset bits. By including some of the offset bits the imprecise lookup value may be more likely to correspond to the target address, but making the combination imprecise may enable the imprecise lookup value to be determined more quickly.

In some examples, the lookup circuitry may be configured to exclude at least one carry operation from calculation of the imprecise lookup value. For example, the imprecise lookup value may be determined by performing an exclusive or operation (XOR) between the base address and the offset. The XOR may act as an approximation to an addition, being equivalent to an addition in which carries are not propagated. The XOR operation may therefore enable a quicker combination of the base address and offset, and can allow both the base address and offset to contribute to identification of the target control information entry (which in some cases may allow the imprecise lookup value to correspond more accurately to the target address than the base address alone) whilst reducing the time required to determine the imprecise lookup value compared to calculating the target address.

In some examples, the lookup circuitry may be configured to determine the imprecise lookup value based on discontiguous portions of the base address. For example, rather than using a contiguous portion of the base address to determine the imprecise lookup value, the imprecise lookup value may include one or more bits from other portions of the base address. In some examples, a lowest bit significance slice of a page address portion of the base address used to identify a memory page may be combined with at least one more significant bit of the base address to provide the imprecise lookup value. By including discontiguous portions of the base address in the imprecise lookup value, the imprecise lookup value may be more representative of the full base address, which may reduce the likelihood of imprecise lookup values encountered at similar times (which may have similar base addresses) from being mapped to the same control information entry.

In some examples the first control information storage may be configured to support a superset of entry types supported by the second control information storage. That is, each of the entry types able to be stored in the second control information storage is also able to be stored in the first control information storage. There may be no type of entry supported by the second control information storage that cannot be stored in the first control information storage. As described above, in some examples, if the imprecise lookup operation in the second control information storage was found to have been based on an imprecise lookup value which did not correspond to the target address, then the target entry may be allocated to the first control information storage. The first control information storage supporting a superset of entries supported by the second control information storage enables entries which may be stored in the second control information storage to be allocated to the first control information storage if the imprecise lookup operation is forced to miss by the checking circuitry.

In some examples, the first control information storage may also support entries which are unable to be stored in the second control information storage (and therefore the first control information storage may support a proper superset of entries supported by the second control information storage). For example, the hardware of the second control information storage may be more restrictive than the hardware used to provide the first control information storage. This can enables the hardware costs of providing the second control information storage to be reduced compared to a similarly sized first control information storage, but may restrict the types of entries supported by the second control information storage. The second control information storage may for example not support translation entries (TLB entries) corresponding to variable page sizes as this might require masking of certain bits, which may not be supported by the second control information storage.

As mentioned above, in some examples the control information comprises address mapping information arranged to identify a physical page of memory corresponding to the given address. The address mapping information may be used for address translations of addresses within the page identified by the given address. Hence, the control information entries may be entries within a translation lookaside buffer (TLB) used to cache translation information stored in page tables in memory. The control information entries may, in addition to the address mapping information, provide further information retrieved from the page tables such as permissions information. The first control information storage may provide a main TLB structure, whilst the second control information storage may provide an auxiliary TLB structure to enable the total number of TLB entries to be increased whilst meeting a particular timing requirement.

In some examples, the second control information storage may act as an eviction cache, and therefore the apparatus may comprise allocation circuitry configured to allocate, to the second control information storage, control information entries evicted from the first control information storage. In other examples, the second control information storage may act as an extension of the first control information storage, and therefore may store entries other than entries evicted from the first control information storage.

In some examples, in at least one mode, lookups in the first control information storage may be accompanied by a parallel lookup in the second control information storage. This can allow data to be retrieved quicker than if the two structures were looked up in series. As discussed above, the imprecise lookup operation for looking up the second control information storage may be quicker than looking up the first control information storage, and hence performing the two lookups in parallel may have little impact on timing. However, in some examples, in at least one mode the lookup circuitry may be configured to perform the precise lookup operation for a given target address without performing the imprecise lookup operation. That is, every lookup in the first control information storage does not necessarily require an associated lookup to be performed in the second control information storage.

For example, the lookup in the second control information storage may be excluded at least in response to a prediction that the imprecise lookup operation will not hit in the second control information storage. For example, prediction schemes may be employed which enable a prediction to be made of whether the lookup may hit in the second control information storage, and power can be saved by not performing the imprecise lookup operation in the second control information storage when such a prediction scheme predicts a miss in the second control information storage.

In some examples, the plurality of control information entries may be configured to store tag information, and the imprecise lookup operation may comprise identifying a candidate set of one or more candidate control information entries using the imprecise lookup value, and determining whether the candidate set comprises the target entry based on a comparison between a tag portion of the target address and the tag information provided by the one or more candidate control information entries. Hence, the imprecise lookup value may be used to identify one or more candidate entries, and the target address may be used to determine whether the candidate set comprises the target control information entry. By using the imprecise lookup value to identify the candidate set, the lookup process can begin before the target address is available, even if later parts of the imprecise lookup operation use the target address. The candidate set of one or more entries could for example correspond to entries in cache ways belonging to a cache set identified by the imprecise lookup value (with the candidate set comprising one entry in the case of a direct mapped structure).

In some examples, the second control information storage may comprise tag storage configured to store the tag information and data storage configured to store the control information. Hence, the second control information storage may be provided in hardware as separate tag and data structures, which may logically be treated as a combined storage structure with entries of the tag storage corresponding to entries of the data storage.

In some examples, the lookup circuitry may be configured to identify no more than one control information entry in the second control information storage for a given imprecise lookup value. For example, the second control information storage may be provided as a direct mapped structure, with the imprecise lookup value used as an index to identify a single candidate entry (for which an associated tag value may be compared to a tag portion of the target address to determine if the candidate entry is the target entry). By identifying a single control information entry, a tag portion of the target address is not required to select the target control information entry for returning data. At least when the second control information storage is provided as a two-part structure having separate data and tag storage, this can reduce the amount of circuitry required for selecting an entry from the data storage and can reduce time taken to output data when there is a hit in the first control information storage.

In some examples, the second control information storage may comprise a greater number of control information entries than the first control information structure. As discussed above, the time taken to perform the imprecise lookup operation in the second control information storage may scale better than the time taken to perform the precise lookup in the first control information storage. As the lookups in the first and second control information storage may be carried out in parallel, this allows a greater number of entries to be provided in the second control information storage than in the first control information storage for a given timing requirement, and hence providing the second control information storage may significantly increase the total number of control information entries which may be supported by the apparatus.

Particular examples will now be described with reference to the Figures.

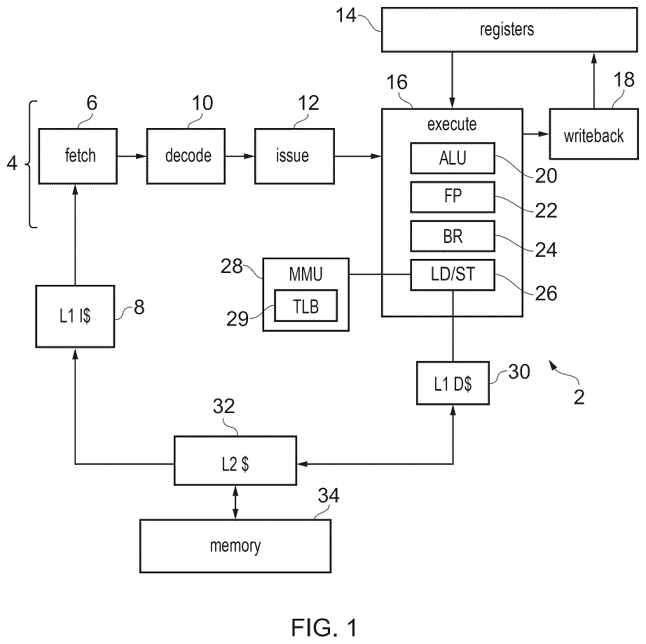

FIG. 1 schematically illustrates an example of a data processing apparatus 2. The data processing apparatus has a processing pipeline 4 (an example of processing circuitry, which could for example form part of a CPU (Central Processing Unit)). The processing circuitry 4 is for executing instructions defined in an instruction set architecture (ISA) to carry out data processing operations represented by the instructions. The processing pipeline 4 includes a number of pipeline stages. In this example, the pipeline stages include a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example in an out-of-order processor a register renaming stage could be included for mapping architectural registers specified by program instructions or micro-operations to physical register specifiers identifying physical registers in the register file 14. In some examples, there may be a one-to-one relationship between program instructions defined in the ISA that are decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 26 for performing load/store operations to access data in a memory system 8, 30, 32, 34.

A memory management unit (MMU) 28 is provided for controlling memory access permission checks and performing address translations between virtual addresses specified by the load/store unit 26, based on operands of data access instructions, and physical addresses identifying storage locations of data in the memory system. The MMU has a translation lookaside buffer (TLB) 29 for caching address translation data from page tables stored in the memory system, where the page table entries of the page tables define the address translation mappings and may also specify access permissions which govern whether a given process executing on the pipeline is allowed to read, write or execute instructions from a given memory region. When a memory access request specifies a virtual address which hits against an entry in the TLB, the translation and subsequent memory access may be performed significantly quicker than if the TLB did not contain the entry and the address translation data instead needed to be retrieved from the page tables in memory. Hence, performance may be improved by increasing the number of entries in the TLB.

While the MMU 28 is shown as associated with the load/store unit 26, the MMU 28 may also be looked up on instruction fetches triggered by the fetch stage 6 (or a separate instruction-side MMU may be implemented to handle instruction fetches, separate from the data-side MMU used by the load/store unit 26 for data accesses—in this case both MMUs can cache in their TLBs 29 information from a shared set of page tables).

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline implementation, and the processor may include many other elements not illustrated for conciseness.

The TLB 29 provides one example of control information storage where performance may be improved by increasing the number of entries in the control information storage, as discussed above. There are further examples of control information storage for which performance of the processor may also be improved by providing further control information entries. For example, increasing a number of entries in value prediction caches and/or branch prediction caches may also enable improved processor performance. Whilst much of the discussion below references a TLB, it will nevertheless be appreciated that the present techniques apply more generally to control information storage provided in a processor.

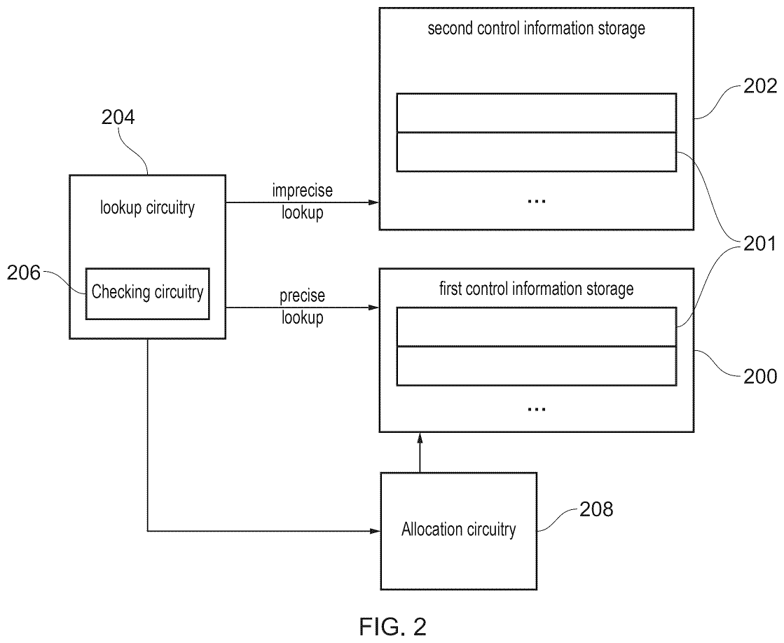

FIG. 2 schematically illustrates an apparatus comprising first control information storage 200 and second control information storage 202. The first and second control information storage provide control information entries 201 storing control information for controlling performance of data processing operations. Control information entries 201 are associated with a given address. The given address may for example be the address of a particular instruction with which the control information is associated, or in some examples may provide a virtual page address corresponding to address translation information. The second control information storage 202 may have capacity for a greater number of control information entries than the first control information storage 200.

The first and second control storage 200, 202 may be provided differently in the apparatus illustrated in FIG. 1 depending on the particular control information being stored. In one example, the first and second control storage may be provided in the MMU 28 as part of the TLB 29.

The apparatus also comprises lookup circuitry 204 configured to perform a precise lookup in the first control information storage 200. The precise lookup seeks to identify a target control information entry associated with a target address determined based on a plurality of address calculation operands, such as a base address and an offset (although further operands could also be involved in the calculation of the target address). In the precise lookup operation, the target address is determined accurately as part of the lookup process. For example, the target address could be determined in advance of the lookup or could be determined as part of the lookup operation to identify the target control information entry.

The lookup circuitry 204 is also configured to perform an imprecise lookup in the second control information storage 202. The imprecise lookup operation seeks to identify a target control information associated with the target address, but can be initiated before the target address is determined. In particular, an imprecise lookup value can be determined based on the target address operands (used for calculating the target address) and used to begin the lookup operation earlier than would otherwise be possible if relying on use of the target address.

The imprecise lookup value may for example comprise one of the address calculation operands taken alone (such as the base address) and hence require no calculation. In other examples, the imprecise lookup value may require some degree of calculation, but this may be greatly simplified compared to calculating the target address. The time taken to determine the target address for performing a precise lookup scales with the total number of possible entries to be looked up, because as the number of entries increases a greater number of bits are needed to select between those entries. Hence, the time taken to perform the precise lookup may scale poorly with the number of entries subject to the precise lookup operation. In comparison, the time taken to perform the imprecise lookup operation may scale much less poorly, because the time taken to determine the imprecise lookup value may be reduced compared to the time taken to determine the target address.

Hence, providing the second control information storage looked up with the imprecise lookup operation allows a greater number of control information entries to be supported by an apparatus having a given timing requirement than an example comprising only the first control information storage looked up using the precise lookup operation.

The apparatus also comprises checking circuitry 206 to determine whether the imprecise lookup value corresponds to the target address. If the imprecise lookup value does not accurately represent the target address then the imprecise lookup operation may not allow an accurate determination to be made regarding whether the second control information storage 202 comprises the target control information entry. If the imprecise lookup value does not correspond to the target address, then the checking circuitry 206 forces the imprecise lookup operation to miss, since any identified entry may be incorrect if the imprecise lookup value does not correspond to the target address.

The determination may be made by the checking circuitry 206 in several ways. For example, if the imprecise lookup value is expected to be equal to at least a portion of the target address then the imprecise lookup value may be compared with the portion of the target address after it has been determined to determine if there is a match, and the imprecise lookup value may be found to not correspond to the target address if there is a mismatch.

If a lookup is performed for a given target address, and the precise lookup misses in the first control information storage 200 and the checking circuitry 206 determines that the imprecise lookup value does not correspond to the target address, then the target control information entry may still be present in the second control information storage. In some techniques, it might be expected that a recovery mechanism is provided to look up the second control information storage using the target address if the imprecise lookup was found to be incorrect to confirm whether or not the target control information entry is present, and if so retrieve the target control information entry. However, the inventors have realised that supporting such a recovery mechanism may be associated with a high overhead. In examples of the present technique, the apparatus also comprises allocation circuitry 208 which can enable an imprecise lookup operation to be used without supporting a recovery mechanism.

The allocation circuitry 208 is responsive to the precise lookup missing in the first control information storage 200 and the checking circuitry 206 determining that the imprecise lookup value does not correspond to the target address, to allocate the target control information entry into the first control information storage 200 (e.g., by retrieving the target control information entry from a cache or from memory). This has the unusual consequence that the same control information entry may be stored simultaneously both in the first control information storage and the second control information storage (if the imprecise lookup value was incorrect, even though the target control information entry was stored in the second control information storage). However, by allocating the target control information entry in the first control information storage, a future request to access the target control information entry can identify the target entry via the precise lookup operation, even if the target entry is one for which the imprecise lookup operation is not effective. This can enable the imprecise lookup operation to be supported with reduced performance impact, because in some examples this allows data to be accessed with at most one repeated lookup, and without supporting a recovery mechanism for the second control information storage.

In some examples, the lookup circuitry may be responsive to a lookup request specifying the target address calculation operands to perform both a precise lookup in the first control information storage, and an imprecise lookup in the second control information storage in parallel, for accessing a target control information entry associated with a target address.

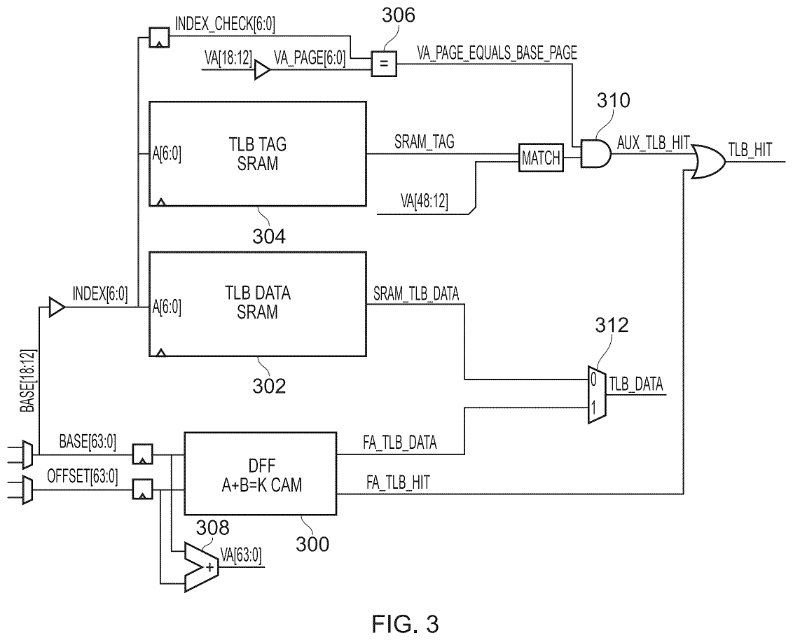

FIG. 3 provides a specific example of the apparatus illustrated in FIG. 2, in which the first and second control information storage comprise TLB storage storing translation information. In the example of FIG. 3, the target address operands comprise a 64 bit base address (BASE) and a 64 bit offset (OFFSET) which, when combined, form a 64 bit virtual address (VA).

The base address and offset are provided as inputs into first control information storage (a main TLB) 300, which uses the base and offset to perform a precise lookup operation for a TLB entry storing translation information corresponding to a virtual address obtained by adding the base and offset. In the example of FIG. 3, the main TLB adds the base and offset as part of the lookup operation, although in other examples an address generation unit (AGU) may be provided prior to the main TLB 300 to determine the target virtual address in advance of the precise lookup operation. The precise lookup in the main TLB returns a hit indication FA_TLB_HIT and data corresponding to a hit entry FA_TLB_DATA.

In parallel with the lookup in the main TLB, bits 18 to 12 of the base address are used to provide an index for performing a lookup in a second control information structure (auxiliary TLB) 302, 304. The auxiliary TLB 302, 304 is formed of a tag structure and a data structure, and the imprecise lookup operation may be performed simultaneously in both structures.

Bits 18 to 12 of the base address identify a memory page (with lower significant bits identifying a particular location within the memory page). It may be reasonably common for the memory page of the base address to be the same as the memory page of the full VA formed by combining the base address and offset. Hence, identifying an entry based on the page bits of the base address may be expected to often return the same entry as using the full VA, and doing so can save considerable time compared to waiting to determine the full VA before beginning the lookup.

In the example of FIG. 3, the imprecise lookup value is used as an index to identify a set in the auxiliary TLB. The auxiliary TLB in FIG. 3 is provided as a direct mapped cache, in which each set provides a single entry, although an N-way set-associative cache for N greater than 1 could also be used. The imprecise lookup value identifies a set comprising one or more candidate entries. Whilst the candidate set is being identified, adder circuitry 308 is provided to add the base and offsets to provide a precise virtual address. At least a tag portion (e.g., bits 48 to 12) of the virtual address may be compared with the tag value(s) stored in the one or more candidate entries (SRAM_TAG) to determine whether any of the hit entries is the target TLB entry, and if so a hit indication (AUX_TLB_HIT) can be returned.

The VA determined by adder 308 is also used to determine whether the imprecise lookup value was accurate. In the example of FIG. 3, a comparator 306 acting as checking circuitry determines whether bits 18 to 12 of the virtual address are the same as bits 18 to 12 of the base address used as the index for looking up the auxiliary TLB. If so, then the same result has been obtained using the imprecise lookup value as would have been achieved using the VA, and therefore the lookup was accurate and the results of the lookup can be used. However, if the imprecise lookup value did not match the determined VA, then the checking circuitry 306 can force the lookup to return a miss. In the example of FIG. 3, the output of the checking circuitry (VA_PAGE_EQUALS_BASE_PAGE) is an input to an AND gate returning the output of the lookup operation, and hence the comparison performed by the checking circuitry needs to pass for AUX_TLB_HIT to indicate a hit.

The hit indication for the main TLB, FA_TLB_HIT, may be combined with the hit indication in the auxiliary TLB, AUX_TLB_HIT, to provide an overall hit indication TLB_HIT for the target TLB entry.

The lookup performed in the auxiliary TLB data structure 302 using the imprecise lookup value identifies an entry corresponding to any entry identified in the tag structure 304. If the lookup in the tag structure resulted in a hit, then the identified data entry (which is looked up in the same way) will also correspond to the target TLB entry. If the auxiliary TLB is direct mapped, then this means that a further tag check is not necessary for the lookup in the data structure 302, and the identified data can be returned as SRAM_TLB_DATA.

A multiplexer 312 is provided for selecting the output data from the TLB lookup (TLB_DATA) from either the main TLB or the auxiliary TLB, depending on whether the lookup in the main TLB resulted in a hit (and hence the multiplexer may be controlled by FA_TLB_HIT).

Excluding a further tag check for the data structure 302 by making the structure direct mapped can avoid unnecessary logic in the path for producing TLB_DATA.

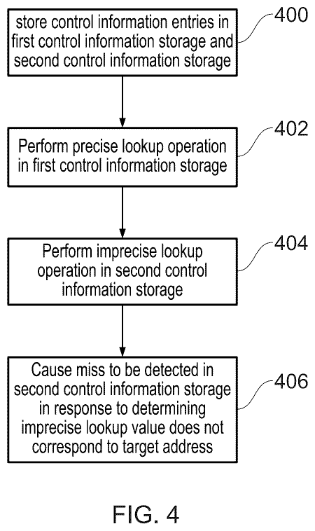

FIG. 4 is a flow diagram illustrating a method of performing lookups for a target control information entry.

At step 400 control information entries are stored in first control information storage and second control information storage.

At step 402, a precise lookup operation is performed in the first control information storage to identify a target control information entry corresponding to a target address. The target address is determined based on address calculation operands for performing the precise lookup operation.

At step 404, which may happen in parallel with step 402, an imprecise lookup operation is performed in the second control information storage to identify the target control information entry corresponding to the target address. The imprecise lookup operation uses an imprecise lookup value which is determined using one or more of the address calculation operands.

The imprecise lookup value has the possibility of not corresponding to the target address due to the inaccuracy in its calculation. Hence, at step 406 a check is carried out to determine whether the imprecise lookup value corresponds to the target address and, if not, a miss is caused to be detected in the lookup of the second control information storage.

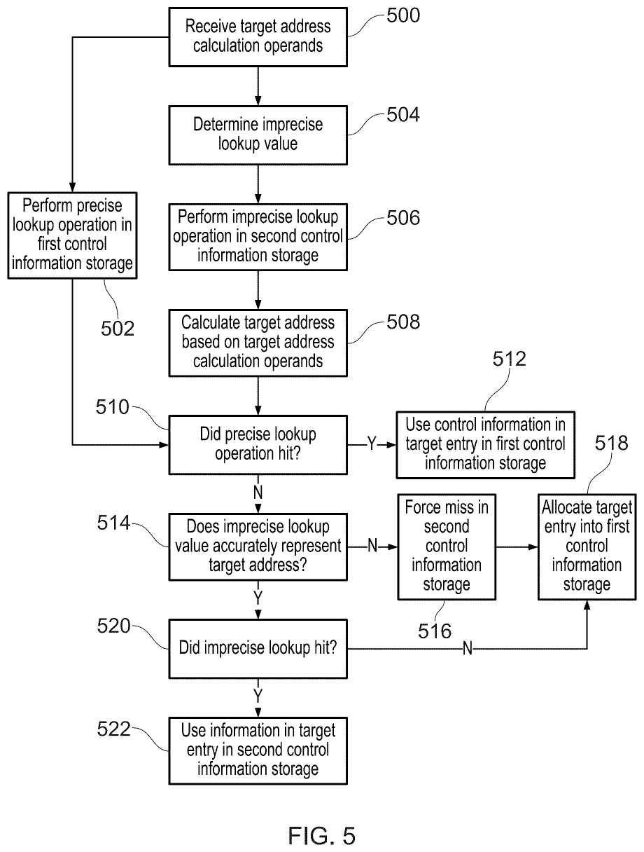

FIG. 5 is a flow diagram illustrating a method of performing lookups for a target control information entry.

At step 500 target address calculation operands are received by lookup circuitry 204.

At step 502, the target address calculation operands are used to determine a target address to perform a precise lookup operation in first control information storage 200.

At step 504, one or more of the target address calculation operands are used to determine an imprecise lookup value. For example a portion of one of the operands may be used as the imprecise lookup value, or the operands could be combined in an imprecise operation.

The imprecise lookup value is used to perform a lookup in second control information storage 202. The imprecise lookup operation may be an accurate lookup, in that a given lookup value may always identify the same entry, with the lookup being imprecise due to being performed using an imprecise lookup value.

At step 508, which may be performed in parallel with steps 502 to 506, the target address calculation operands are used to determine the target address precisely.

At step 510 it is determined whether the precise lookup operation performed at step 502 resulted in a hit. If so, then a hit indication may be returned (e.g., TLB_HIT in FIG. 3) and at step 512 control information stored in the hit control information entry may be returned for use by processing circuitry (e.g., TLB_DATA in FIG. 3).

If the precise lookup operation did not hit in the first control information storage, then it is determined at step 514 whether the imprecise lookup value determined at step 504 corresponded to the target address determined at step 508. The exact determination depends on how the imprecise lookup value was determined, but in general step 514 seeks to determine whether the lookup at step 506 would enable the target control information entry to be identified or not. If the imprecise lookup value did not correspond to the target address, then at step 516 the checking circuitry 206 forces a miss in the second control information storage (e.g., forces AUX_TLB_HIT=0 in FIG. 3), to prevent incorrect control information being returned.

If the lookup in the first control information storage missed, and the imprecise lookup value did not correspond to the target address, then to enable forward progress to be made, at step 518 the target control information entry is derived from information stored in a further level of cache or memory and allocated into the first control information storage.

If the allocation at step 518 causes an eviction from the first control information storage, then in some examples the evicted entry may be allocated to the second control information storage (if necessary, causing an entry to be evicted from the second control information storage), with the second control information storage acting as an eviction cache.

If the imprecise lookup value did correspond to the target address then at step 520 it is determined whether the lookup in the second control information storage hit or missed.

If the imprecise lookup value corresponded to the target address but the lookup in the second control information storage resulted in a miss, then the target control information entry is not present in either the first or second control information storage and hence in this situation the target control information entry is also allocated into the first (or second) control information storage.

If the imprecise lookup value corresponded to the target address and hit, then at step 522 the control information can be returned from the target control information entry identified in the second control information storage.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

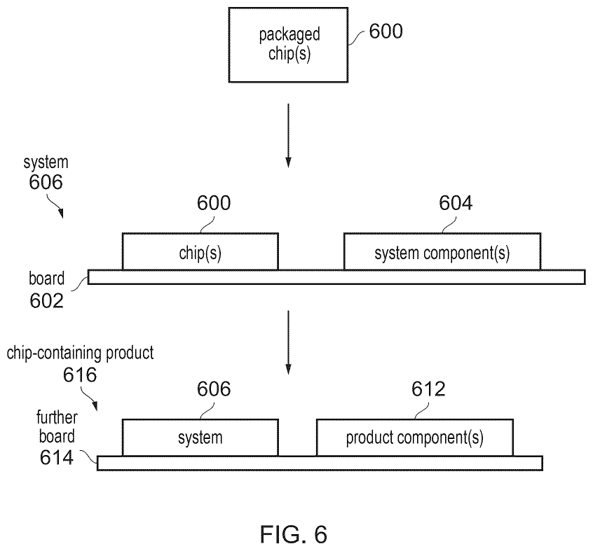

As shown in FIG. 6, one or more packaged chips 600, with the apparatus described above implemented on one chip or distributed over two or more of the chips, are manufactured by a semiconductor chip manufacturer. In some examples, the chip product 600 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 600 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. modular chips which, when combined, provide the functionality of a chip) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 600 are assembled on a board 602 together with at least one system component 604 to provide a system 606. For example, the board may comprise a printed circuit board. The board substrate may be made of any of a variety of materials, e.g. plastic, glass, ceramic, or a flexible substrate material such as paper, plastic or textile material. The at least one system component 604 comprise one or more external components which are not part of the one or more packaged chip(s) 600. For example, the at least one system component 604 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 616 is manufactured comprising the system 606 (including the board 602, the one or more chips 600 and the at least one system component 604) and one or more product components 612. The product components 612 comprise one or more further components which are not part of the system 606. As a non-exhaustive list of examples, the one or more product components 612 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 606 and one or more product components 612 may be assembled on to a further board 614.

The board 602 or the further board 614 may be provided on or within a device housing or other structural support (e.g. a frame or blade) to provide a product which can be handled by a user and/or is intended for operational use by a person or company.

The system 606 or the chip-containing product 616 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In some examples, an apparatus comprises first control information storage and second control information storage, to store control information entries corresponding to a given address and providing control information for controlling processing operations relating to the given address. Lookup circuitry is configured to perform a precise lookup operation in the first control information storage to identify a target control information entry corresponding to a target address determined based on a plurality of target address calculation operands, and perform an imprecise lookup operation in the second control information storage to identify the target control information entry based on an imprecise lookup value. Checking circuitry is configured to cause a miss to be detected in the second control information storage in response to determining that the imprecise lookup value does not correspond to the target address.

Some examples are set out in the following clauses:
1. An apparatus, comprising:
   first control information storage and second control information storage,
   wherein the first control information storage and the second control information storage are configured to store a plurality of control information entries, each control information entry corresponding to a given address and providing control information for controlling processing operations relating to the given address;
   lookup circuitry configured to:
      perform a precise lookup operation in the first control information storage to identify a target control information entry corresponding to a target address determined based on a plurality of target address calculation operands, and
      perform an imprecise lookup operation in the second control information storage to identify the target control information entry based on an imprecise lookup value determined based on at least one of the target address calculation operands; and
      checking circuitry configured to cause a miss to be detected in the second control information storage in response to determining that the imprecise lookup value does not correspond to the target address determined based on the plurality of target address calculation operands.
2. The apparatus according to clause 1, comprising allocation circuitry responsive to a determination that the precise lookup operation for a given target address missed in the first control information storage and the imprecise lookup value did not correspond to the given target address, to allocate a control information entry corresponding to the given target address in the first control information storage.
3. The apparatus according to any preceding clause, wherein the lookup circuitry is responsive to a determination that the imprecise lookup value used for a given imprecise lookup operation does not correspond to the target address, to allow forward progress based on the miss in the second control information storage without attempting to repeat the given imprecise lookup operation using a lookup value corresponding to the target address.
4. The apparatus according to any preceding clause, wherein the lookup circuitry is configured to initiate the imprecise lookup operation for a given target control information entry based on at least one of the target address calculation operands before the target address is made available.
5. The apparatus according to any preceding clause, comprising address calculation circuitry to determine the target address based on a combination of a base address and an offset, wherein the lookup circuitry is configured to exclude the offset from determination of the imprecise lookup value.
6. The apparatus according to any of clauses 1 to 4, comprising address calculation circuitry to determine the target address based on a combination of a base address and an offset, wherein the lookup circuitry is configured to determine the imprecise lookup value based on an imprecise combination of the base address and offset.
7. The apparatus according to clause 6, wherein the lookup circuitry is configured to exclude at least one carry operation from determination of the imprecise lookup value.
8. The apparatus according to any of clauses 5 to 7, wherein the lookup circuitry is configured to determine the imprecise lookup value based on discontiguous portions of the base address.
9. The apparatus according to any preceding clause, wherein the first control information storage is configured to support a superset of entries supported by the second control information storage.
10. The apparatus according to any preceding clause, wherein the control information comprises address mapping information identifying a physical page of memory corresponding to the given address.
11. The apparatus according to any preceding clause comprising allocation circuitry configured to allocate, to the second control information storage, control information entries evicted from the first control information storage.
12. The apparatus according to any preceding clause, wherein in at least one mode the lookup circuitry is configured to perform the precise lookup operation for a given target address without performing the imprecise lookup operation at least in response to a prediction that the imprecise lookup operation will not hit in the second control information storage.
13. The apparatus according to any preceding clause, wherein the plurality of control information entries are configured to store tag information, and the imprecise lookup operation comprises identifying a candidate set of one or more candidate control information entries using the imprecise lookup value, and determining whether the candidate set comprises the target control information entry based on a comparison between a tag portion of the target address and the tag information provided by the one or more candidate control information entries.
14. The apparatus according to any preceding clause, wherein the lookup circuitry is configured to identify no more than one control information entry in the second control information storage for a given imprecise lookup value.
15. The apparatus according to any preceding clause, wherein the second control information storage comprises a greater number of control information entries than the first control information structure.
16. A system comprising:
   the apparatus of any preceding clause, implemented in at least one packaged chip;
   at least one system component; and
   a board,
   wherein the at least one packaged chip and the at least one system component are assembled on the board.
17. A chip-containing product comprising the system of clause 16, wherein the system is assembled on a further board with at least one other product component.
18. A method, comprising:
   storing a plurality of control information entries in first control information storage and second control information storage, each control information entry corresponding to a given address and providing control information for controlling processing operations relating to the given address;
   performing a precise lookup operation in the first control information storage to identify a target control information entry corresponding to a target address determined based on a plurality of target address calculation operands;
   performing an imprecise lookup operation in the second control information storage to identify the target control information entry based on an imprecise lookup value determined based on at least one of the target address calculation operands; and
   causing a miss to be detected in the second control information storage in response to determining that the imprecise lookup value does not correspond to the target address determined based on the plurality of target address calculation operands.
19. Computer-readable code for fabrication of an apparatus, comprising:
   first control information storage and second control information storage,
   wherein the first control information storage and the second control information storage are configured to store a plurality of control information entries, each control information entry corresponding to a given address and providing control information for controlling processing operations relating to the given address;
   lookup circuitry configured to:
      perform a precise lookup operation in the first control information storage to identify a target control information entry corresponding to a target address determined based on a plurality of target address calculation operands, and
      perform an imprecise lookup operation in the second control information storage to identify the target control information entry based on an imprecise lookup value determined based on at least one of the target address calculation operands; and
   checking circuitry configured to cause a miss to be detected in the second control information storage in response to determining that the imprecise lookup value does not correspond to the target address determined based on the plurality of target address calculation operands.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus, comprising:
first control information storage and second control information storage,
wherein the first control information storage and the second control information storage are configured to store a plurality of control information entries, each control information entry corresponding to a given address and providing control information for controlling processing operations relating to the given address;
lookup circuitry configured to:
perform a precise lookup operation in the first control information storage to identify a target control information entry corresponding to a target address determined based on a plurality of target address calculation operands, and
perform an imprecise lookup operation in the second control information storage to identify the target control information entry based on an imprecise lookup value determined based on at least one of the target address calculation operands; and
checking circuitry configured to cause a miss to be detected in the second control information storage in response to determining that the imprecise lookup value does not correspond to the target address determined based on the plurality of target address calculation operands.

2. The apparatus according to claim 1, comprising allocation circuitry responsive to a determination that the precise lookup operation for a given target address missed in the first control information storage and the imprecise lookup value did not correspond to the given target address, to allocate a control information entry corresponding to the given target address in the first control information storage.

3. The apparatus according to claim 1, wherein the lookup circuitry is responsive to a determination that the imprecise lookup value used for a given imprecise lookup operation does not correspond to the target address, to allow forward progress based on the miss in the second control information storage without attempting to repeat the given imprecise lookup operation using a lookup value corresponding to the target address.

4. The apparatus according to claim 1, wherein the lookup circuitry is configured to initiate the imprecise lookup operation for a given target control information entry based on at least one of the target address calculation operands before the target address is made available.

5. The apparatus according to claim 1, comprising address calculation circuitry to determine the target address based on a combination of a base address and an offset, wherein the lookup circuitry is configured to exclude the offset from calculation of the imprecise lookup value.

6. The apparatus according to claim 1, comprising address calculation circuitry to determine the target address based on a combination of a base address and an offset, wherein the lookup circuitry is configured to determine the imprecise lookup value based on an imprecise combination of the base address and offset.

7. The apparatus according to claim 6, wherein the lookup circuitry is configured to exclude at least one carry operation from determination of the imprecise lookup value.

8. The apparatus according to claim 5, wherein the lookup circuitry is configured to determine the imprecise lookup value based on discontiguous portions of the base address.

9. The apparatus according to claim 1, wherein the first control information storage is configured to support a superset of entries supported by the second control information storage.

10. The apparatus according to claim 1, wherein the control information comprises address mapping information identifying a physical page of memory corresponding to the given address.

11. The apparatus according to claim 1 comprising allocation circuitry configured to allocate, to the second control information storage, control information entries evicted from the first control information storage.

12. The apparatus according to claim 1, wherein in at least one mode the lookup circuitry is configured to perform the precise lookup operation for a given target address without performing the imprecise lookup operation at least in response to a prediction that the imprecise lookup operation will not hit in the second control information storage.

13. The apparatus according to claim 1, wherein the plurality of control information entries are configured to store tag information, and the imprecise lookup operation comprises identifying a candidate set of one or more candidate control information entries using the imprecise lookup value, and determining whether the candidate set comprises the target control information entry based on a comparison between a tag portion of the target address and the tag information provided by the one or more candidate control information entries.

14. The apparatus according to claim 1, wherein the lookup circuitry is configured to identify no more than one control information entry in the second control information storage for a given imprecise lookup value.

15. The apparatus according to claim 1, wherein the second control information storage comprises a greater number of control information entries than the first control information structure.

16. A system comprising:
the apparatus of claim 1, implemented in at least one packaged chip;
at least one system component; and
a board,
wherein the at least one packaged chip and the at least one system component are assembled on the board.

17. A chip-containing product comprising the system of claim 16, wherein the system is assembled on a further board with at least one other product component.

18. A method, comprising:
storing a plurality of control information entries in first control information storage and second control information storage, each control information entry corresponding to a given address and providing control information for controlling processing operations relating to the given address;
performing a precise lookup operation in the first control information storage to identify a target control information entry corresponding to a target address determined based on a plurality of target address calculation operands;
performing an imprecise lookup operation in the second control information storage to identify the target control information entry based on an imprecise lookup value determined based on at least one of the target address calculation operands; and
causing a miss to be detected in the second control information storage in response to determining that the imprecise lookup value does not correspond to the target address determined based on the plurality of target address calculation operands.

19. A non-transitory computer-readable medium storing computer-readable code for fabrication of an apparatus, comprising:
first control information storage and second control information storage,
wherein the first control information storage and the second control information storage are configured to store a plurality of control information entries, each control information entry corresponding to a given address and providing control information for controlling processing operations relating to the given address;
lookup circuitry configured to:
perform a precise lookup operation in the first control information storage to identify a target control information entry corresponding to a target address determined based on a plurality of target address calculation operands, and
perform an imprecise lookup operation in the second control information storage to identify the target control information entry based on an imprecise lookup value determined based on at least one of the target address calculation operands; and
checking circuitry configured to cause a miss to be detected in the second control information storage in response to determining that the imprecise lookup value does not correspond to the target address determined based on the plurality of target address calculation operands.
